(19) United States
(12) Patent Application Publication
(10) Pub. No.: US 2007/0202287 A1
(43) Pub. Date: Aug. 30, 2007

(54) Method of producing fuel hose material and fuel hose material produced by the same

(75) Inventor: Kazutaka Katayama, Komaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOKAI RUBBER INDUSTRIES, LTD., Komaki-shi (JP)

(21) Appl. No.: 11/707,985

(22) Filed: Feb. 20, 2007

(30) Foreign Application Priority Data
Feb. 28, 2006 (JP) 2006-053115

(51) Int. Cl. B32B 1/08; B29C 47/00

(52) U.S. Cl. 428/36.9; 523/215

(57) ABSTRACT

A method of producing a fuel hose material which is obtained at low costs and has excellent properties such as antistatic property, resistance to thermal aging and resistance to sour gasoline, and a material produced by the method. The method includes the steps of: dispersing a carbon nanotube in a polar plasticizer comprising at least one of a sulfonamide plasticizer and an ester plasticizer; and blending the resulting compound into a polyamide resin having a relative viscosity (ηr) of 2.5 to 3.5, in which the carbon nanotube is present in a proportion of not less than 7 wt %.

### BACKGROUND OF THE INVENTION

1. Field of the Invention

The present invention relates to a method of producing a fuel hose material and a fuel hose material produced by the method, specifically, a method of producing a fuel hose material which is suitable for forming an inner layer of a fuel hose used for transporting fuel for automobiles or the like such as gasoline, alcohol-containing gasoline (gasohol), or diesel fuel, and a fuel hose material produced by the method.

2. Description of the Art

A fuel hose for gasoline is required to be provided with electrically conductive properties on an inner layer thereof so as to avoid an occurrence of ignition due to a spark caused by contact electrification of a fuel charged with static electricity generated at fuel pumps. For example, a hose disclosed in Japanese Unexamined Patent Publication No. HEI 7-173446 has an inner layer comprising: a fluororesin such as ethylene-tetrafluoroethylene copolymer (ETFE) which is excellent in resistance to thermal aging and sour gasoline, and an electrically conductive carbon black blended for imparting electrical conductivity to the fluororesin. The inner layer of ETFE is generally subjected to adhesion treatment such as ETFE modification and surface treatment of an outer peripheral surface of the inner layer for ensuring adhesion to an outer layer laminated on the outer peripheral surface of the inner layer.

There is further proposed a hose having an inner layer comprising a polyamide resin and an electrically conductive carbon black blended for imparting electrical conductivity to the polyamide resin. Further, in Japanese Unexamined Patent Publication No. 2004-250707, a carbon nanotube, which has recently been drawing attention as a new electrically conductive material, is proposed for imparting electrical conductivity to a hose. In many cases, the carbon nanotube is used in a form of a masterbatch formed with a low-viscosity resin, namely, low molecular weight resin of injection grade, such as polyamide 6 (PA 6) as disclosed in Japanese Unexamined Patent Publication No. 2003-100147.

However, the ETFE used in the hose disclosed in Japanese Unexamined Patent Publication No. HEI 7-173446 requires increased costs for materials and adhesion treatment for laminating another layer to the ETFE layer.

On the other hand, since the use of the polyamide resin reduces costs for materials, a hose having an inner layer formed of a polyamide resin imparted with electrical conductivity by blending an electrically conductive carbon black is advantageous in view of the costs for materials. However, due to significant inferiority in thermal aging resistance and sour gasoline resistance thereof, the hose comprising polyamide resin is not reliable. Further, where a carbon nanotube is used as an electrically conductive material in the polyamide resin, since a low-viscosity polyamide resin, namely, a low molecular weight polyamide resin is used for forming a masterbatch, properties of the resulting hose such as resistance to thermal aging are significantly deteriorated. That is, since the property and the molecular weight are closely related to each other, the use of the material of low molecular weight leads to the above deterioration in the properties.

In view of the foregoing, it is an object of the present invention to provide a method of producing a fuel hose which is obtained at low costs and has excellent properties such as antistatic property, resistance to thermal aging and resistance to sour gasoline, and a material produced by the method.

### SUMMARY OF THE INVENTION

To achieve the aforesaid object, a first aspect of the present invention is a method of producing a fuel hose material, including the steps of dispersing a carbon nanotube in a polar plasticizer which comprises at least one of sulfonamide plasticizer and ester plasticizer; and blending the resulting compound into a polyamide resin having a relative viscosity (ηr) of 2.5 to 3.5, in which the carbon nanotube is present in a proportion of not less than 7 wt %, and a second aspect of the present invention is a fuel hose material produced by the method according to the first aspect. The relative viscosity (ηr) as used herein refers to a viscosity ratio of 1% solution of concentrated sulfuric acid (95%) to concentrated sulfuric acid (95%) measured by Ostwald viscometer at 30° C.

The inventor of the present invention has conducted intensive studies to solve the above problems. As a result, the inventor has found that the above object can be achieved by using a specific amount of carbon nanotube for providing antistatic property, specifically by producing a fuel hose material in which the specific amount of carbon nanotube is dispersed in a specific plasticizer, and the resulting fluid containing the dispersed carbon nanotube is blended into a polyamide resin having a specific viscosity (a polyamide resin of extrusion grade). Thus, the present invention has been attained. According to this method, since a masterbatch is not formed with a low molecular weight resin of injection grade, deterioration of resistance to thermal aging is reduced and resistance to sour gasoline is improved. Further, the specific plasticizer is capable of improving the uniformity of dispersion of carbon nanotube in the extrusion grade polyamide in which the uniform dispersion is difficult. Thus, the above method expedites production of desired fuel hose materials.

Accordingly, a fuel hose material according to the present invention is produced by dispersing a carbon nanotube in a polar plasticizer such as a sulfonamide plasticizer and an ester plasticizer, and blending thus obtained liquid containing the dispersed carbon nanotube into a polyamide resin having a specific viscosity (a polyamide resin of extrusion grade). With this method, since the forming of a masterbatch in conventional methods is not necessary, deteriorations in the resistance to thermal aging and resistance to sour gasoline caused by the forming of a masterbatch can be eliminated. Further, uniform dispersion of the carbon nanotube in this method improves imparting of electrical conductivity, and hence, a fuel hose material having an antistatic property that is required to a material for an inner layer of a fuel hose can be obtained by blending a specified amount of carbon nanotube. Furthermore, the blending of carbon nanotube into a specific plasticizer prevents scattering of and improves uniform dispersion of the carbon nanotube, and the plasticizer which functions also as a lubricant reduces a stress to the resin during the kneading process of the fuel hose material. Accordingly, the inventive method allows the efficient production of desired fuel hose materials.

Particularly, where polyamide 11 (PA11), polyamide 12 (PA12), or polyamide 912 (PA912) is used as the polyamide resin, a fuel hose material having further improved thermal aging resistance is obtained.

Where the specific polar plasticizer presents in the material in a proportion of 5 wt % to 15 wt %, a desired fuel hose material of a further improved quality can be obtained.

### DESCRIPTION OF THE PREFERRED EMBODIMENTS

Embodiments of the present invention will hereinafter be described in detail.

A method of producing a fuel hose material according to the present invention includes, as mentioned above, the steps of dispersing a carbon nanotube in a polar plasticizer which comprises at least one of sulfonamide plasticizer and ester plasticizer; and blending the liquid containing the dispersed nanotube into a polyamide resin having a relative viscosity (ηr) of 2.5 to 3.5, in which the carbon nanotube is present in a proportion of not less than 7 wt %.

The polyamide resin used in the method of the present invention has a relative viscosity (ηr) of 2.5 to 3.5, preferably, 2.7 to 3.5, so that the deteriorations in thermal aging resistance and sour gasoline resistance are prevented. The polyamide resin having the relative viscosity (ηr) of 2.5 to 3.5 as used herein is the polyamide resin of extrusion grade and has a higher viscosity than a polyamide resin of injection grade which has a relative viscosity (ηr) of 2.0 to 2.5 and is generally used for forming a masterbatch. The polyamide resin of extrusion grade has a lower viscosity than a polyamide resin of blow grade which has a relative viscosity (ηr) of over 3.5. The polyamide resin to be used in the method of producing a fuel hose material of the present invention is not limited as long as the resin has the above specific viscosity, but preferably used examples of the resin include polyamide 11 (PA11), polyamide 12 (PA12), and polyamide 912 (PA912), which may be used alone or in combination. In the production method of a fuel hose material according to the present invention, the use of the specific polyamide resin allows the production of a fuel hose material having an improved resistance to thermal aging or the like.

As the carbon nanotube, a single-walled carbon nanotube, a double-walled carbon nanotube or the like is used. The carbon nanotube has a diameter of 0.8 nm to 3.0 nm and a length of 100 nm to 2000 nm.

Examples of the polar plasticizer for dispersing the carbon nanotube include a sulfonamide plasticizer and an ester plasticizer, which may be used alone or in combination.

The sulfonamide plasticizer to be used is not particularly limited, but n-butylbenzene sulfonamide is preferably used in the present invention.

Examples of the ester plasticizer include phthalate ester, trimellitate ester, aliphatic dibasic acid ester, phosphoric ester, ricinoleate ester, polyester epoxidized ester, acetate ester, and condensed phosphoric ester.

Using the above materials, the method of producing a fuel hose material is carried out as follows.

A carbon nanotube is dispersed in the specific polar plasticizer. The resulting liquid containing the dispersed carbon nanotube is blended into the specific polyamide resin. The proportion of carbon nanotube based on the whole fuel hose material prepared by this method is not less than 7 wt %. Preferably, the proportion of the carbon nanotube is 7 wt % to 15 wt %. Where the proportion of carbon nanotube is less than 7 wt %, the resulting material does not have a sufficient antistatic property that is required to a material for forming an inner layer of a fuel hose.

The proportion of the specific polar plasticizer based on the whole fuel hose material prepared by this method is preferably 5 wt % to 15 wt %, more preferably, 7 wt % to 14 wt %. With this proportion, a desired fuel hose material of improved quality is obtained.

It is preferable to blend the liquid containing the carbon nanotube into the specific polyamide resin by means of a twin-screw kneading extruder. Since the polyamide resin used in the present invention is of extrusion grade, the twin-screw kneading extruder is suitable for blending the materials of the present invention.

Thus obtained fuel hose material preferably has a volume resistivity of not more than 1×10⁸ Ω·cm, more preferably, not more than 1×10⁶ Ω·cm. The volume resistivity of the fuel hose material is measured in conformity with JIS (Japanese Industrial Standards) K 6271.

While the fuel hose material may be directly used for forming a hose, the material is generally formed into pellets by being cooled in a water bath, and then, pelletized by means of a pelletizer. The pelletized material is melted before being used as a fuel hose material.

The fuel hose material is extruded into a tube shape to obtain a fuel hose of the tube shape. While the fuel hose material may be formed into a fuel hose having a single layer structure, the material may be formed into an inner layer of a multi-layer hose by, for example, extruding another material on an outer peripheral surface thereof. In the latter case, interlayer adherence can be obtained without treatments for adherence such as modification and surface treatment which are required for adhering a conventional inner layer formed of ETFE or the like.

The method of producing a fuel hose material and a fuel hose material produced by the method according to the present invention are advantageously employed as a method for producing a fuel hose material and a fuel hose material produced by the method for forming a fuel hose, particularly for forming an inner layer of a multi-layer hose or the whole of a single-layer hose, to be used for transporting fuels for automobiles or the like such as gasoline, alcohol-containing gasoline and diesel fuel.

Next, an explanation will be given to Examples of the present invention and Comparative Examples which do not impose any limitation on the present invention.

### EXAMPLE 1

An extrusion grade PA11 (Rilsan BESN O TL having a relative viscosity (ηr) of 3.3 available from Arkema K.K.), a plasticizer (n-butylbenzene sulfonamide) and a carbon nanotube (single-walled carbon nanotube available from Carbon Nanotechnologies Inc.) were prepared. The carbon nanotube was dispersed in the plasticizer. While blending the obtained liquid containing the dispersed carbon nanotube into the polyamide resin by means of a liquid blending pump, the blend was kneaded by means of a twin-screw kneading extruder. Thus, a fuel hose material comprising 78 wt % of resin, 12 wt % of plasticizer and 10 wt % of carbon nanotube was produced.

### EXAMPLE 2

A fuel hose material was produced in the same manner as Example 1, except that the proportion of carbon nanotube present in the material was 7 wt %. The proportions of resin and plasticizer were 80 wt % and 13 wt %, respectively.

### COMPARATIVE EXAMPLE 1

A fuel hose material was produced in the same manner as Example 1, except that an extrusion grade PA11 (BESN P40, having a relative viscosity (ηr) of 3.2 available from Arkema K.K.) was used in place of the PA11 used in Example 1 and that carbon nanotube was not blended.

### COMPARATIVE EXAMPLE 2

A fuel hose material was produced in the same manner as Example 1, except that the proportion of carbon nanotube present in the material was 5 wt %. The proportions of resin and plasticizer were 82 wt % and 13 wt %, respectively.

### COMPARATIVE EXAMPLE 3

A fuel hose material was produced in the same manner as Example 1, except that an injection grade PA11 (Rilsan BMN O TL, having a relative viscosity (ηr) of 2.2 available from Arkema K.K.) was used in place of the PA11 used in Example 1.

### COMPARATIVE EXAMPLE 4

A fuel hose material was produced by dryblending 50 parts by weight of the extrusion grade PA11 (Rilsan BESN P40, having a relative viscosity (ηr) of 3.2 available from Arkema K.K.) and 50 parts by weight of the material produced in Example 1.

The fuel hose materials thus produced were evaluated for characteristic properties thereof in the following manner. The Prior Art Example in Table 1 shows results of evaluations conducted in the same manner as Examples and Comparative Examples to a fuel hose material produced with using a PA12 (LX9102 available from Degussa AG) which was imparted with electrical conductivity by a carbon black.

### Volume Resistivity

A sheet having a thickness of 1 mm was formed of each fuel hose material by means of injection molding, and volume resistivity of each material was measured in conformity with JIS K 6271.

### Surface Resistivity

A sheet having a thickness of 1 mm was formed of each fuel hose material by means of injection molding, and surface resistivity of each material was measured in conformity with JIS K 6271.

### Ordinary State Properties

A sheet having a thickness of 1 mm was formed of each fuel hose material by means of injection molding, and dumbbell specimens of ASTM #4 were cut out from the sheet. Yield point stress (MPa), Tensile strength (MPa) and Elongation at break (%) of the specimens were measured in conformity with ASTM D638.

### Thermal Aging Resistance

After the dumbbell specimens used in the evaluations of the Ordinary state properties were allowed to stand in a high temperature atmosphere of 120° C. for 360 hours, Thermal aging resistance tests were conducted to the specimens. Thereafter, Yield point stress (MPa) Tensile strength (MPa) and Elongation at break (%) of the specimens were measured in conformity with ASTM D638 in the same manner as the evaluations of the Ordinary state properties. Further, each dumbbell specimen was bent at a chuck portion thereof by 180 degrees for visually inspecting cracks or folds.

### Sour Gasoline Resistance

A model of degraded (sour) gasoline was prepared by blending 5 wt % of lauroyl peroxide (LPO) into Fuel C (50 vol % of toluene+50 vol % of isooctane). The dumbbell specimens used in the evaluations of the Ordinary state properties were immersed into the model of degraded gasoline and allowed to stand in the atmosphere of 60° C. for 168 hours, and then, the model of degraded gasoline was exchanged and the dumbbell specimens were allowed to stand in an atmosphere of 60° C. for further 168 hours. Thereafter, the dumbbell specimens were taken out from the model of degraded gasoline for measurements of Yield point stress (MPa), Tensile strength (MPa) and Elongation at break (%) in conformity with ASTM D638 in the same manner as the evaluations of the Ordinary state properties. Then, Volume change (%) of each specimen was measured. Further, each dumbbell specimen was bent at a chuck portion thereof by 180 degrees for visually inspecting for cracks or folds.

TABLE 1

| | EXAMPLE | | COMPARATIVE EXAMPLE | | | | PRIOR ART |
|---|---|---|---|---|---|---|---|
| | 1 | 2 | 1 | 2 | 3 | 4 | EXAMPLE |
| VOLUME RESISTIVITY | 1.9 × 10⁵ | 8.3 × 10⁵ | 1.4 × 10¹¹ | 1.7 × 10¹⁰ | 3.6 × 10³ | 1.8 × 10¹⁰ | 2.0 × 10⁴ |
| (Ω · cm) | | | | | | | |
| SURFACE RESISTIVITY | 4.8 × 10⁴ | 6.0 × 10⁵ | 3.6 × 10¹¹ | 3.0 × 10⁹ | 1.8 × 10⁴ | 8.0 × 10⁹ | 1.6 × 10⁵ |
| (Ω_{sq}) | | | | | | | |

ORDINARY STATE PROPERTIES

| | | | | | | | |
|---|---|---|---|---|---|---|---|
| YIELD POINT STRESS | 30.1 | 27.0 | — | 24.8 | 43.5 | 23.1 | 26.1 |
| (MPa) | | | | | | | |
| TENSILE STRENGTH | 55.4 | 61.4 | 78.6 | 68.3 | 44.8 | 63.8 | 52.3 |
| (MPa) | | | | | | | |
| ELONGATION AT | 280 | 300 | 380 | 320 | 230 | 310 | 280 |
| BREAK(%) | | | | | | | |

THERMAL AGING RESISTANCE

| | | | | | | | |
|---|---|---|---|---|---|---|---|
| YIELD POINT STRESS | 43.5 | 42.5 | 39.9 | 41.0 | — | 41.2 | 41.8 |
| (MPa) | | | | | | | |
| TENSILE STRENGTH | 52.1 | 52.6 | 65.8 | 53.2 | 45.3 | 57.8 | 32.4 |
| (MPa) | | | | | | | |
| ELONGATION AT | 240 | 250 | 320 | 270 | 10 | 310 | 40 |
| BREAK(%) | | | | | | | |
| CRACKS/FOLDS | NIL | NIL | NIL | NIL | FOLDS | NIL | CRACKS |

SOUR GASOLINE RESISTANCE

| | | | | | | | |
|---|---|---|---|---|---|---|---|
| YIELD POINT STRESS | 26.0 | 25.1 | 20.4 | 23.5 | 32.5 | 23.8 | 22.5 |
| (MPa) | | | | | | | |
| TENSILE STRENGTH | 45.2 | 48.5 | 53.6 | 45.7 | 36.8 | 62.2 | 22.8 |
| (MPa) | | | | | | | |
| ELONGATION AT | 280 | 290 | 290 | 270 | 190 | 340 | 40 |
| BREAK(%) | | | | | | | |
| VOLUME CHANGE(%) | +1 | +1 | ±0 | ±0 | +5 | ±0 | +7 |
| CRACKS/FOLDS | NIL | NIL | NIL | NIL | NIL | NIL | CRACKS |

As can be understood from the results shown in Table 1, the fuel hose materials of Examples were low in Volume resistivity and Surface resistivity, showing less deterioration in the properties thereof even after the Thermal aging resistance tests and the Sour gasoline resistance tests. Further, cracks or folds were not observed in the materials of Examples even after the Thermal aging resistance tests and the Sour gasoline resistance tests, and hence, the materials of Examples are excellent as materials for fuel hoses.

On the other hand, the fuel hose materials of Comparative Examples 1, 2 and 4 did not achieve values required to a fuel hose material in Volume resistivity and Surface resistivity. Further, significant deteriorations in the properties thereof were observed after the Thermal aging resistance tests and the Sour gasoline resistance tests, specifically, significant deteriorations were observed in the Tensile Strength in the Thermal aging resistance tests and in the Tensile strength and the Elongation at break in the Sour gasoline resistance tests.

The fuel hose material of Comparative Example 3 had preferable Volume resistivity and Surface resistivity as a fuel hose material. However, in the Comparative Example 3, deteriorations in the Elongation at break and Folds were observed after the Thermal aging resistance testy and further, significant deteriorations in the Elongation at break and in the Volume change were observed after the Sour gasoline resistance test. Therefore, a fuel hose material provided with all the features required in the present invention could not be obtained in Comparative Examples 1 to 4. In the Prior Art Example, cracks were observed after the Thermal aging resistance test and the Sour gasoline resistance test, and significant deterioration in the Volume change after the Sour gasoline resistance test was observed.

The method of producing a fuel hose material and a fuel hose material produced by the method according to the present invention are advantageously employed as a method for producing a fuel hose material and a fuel hose material produced by the method for forming a fuel hose, particularly for forming an inner layer of a multi-layer hose or the whole of a single-layer hose, to be used for transporting fuels for automobiles or the like such as gasoline, alcohol-containing gasoline and diesel fuel.

What is claimed is:

1. A method of producing a fuel hose material, including the steps of: dispersing a carbon nanotube in a polar plasticizer comprising at least one of a sulfonamide plasticizer and an ester plasticizer; and blending the resulting compound into a polyamide resin having a relative viscosity (ηr) of 2.5 to 3.5, the carbon nanotube being present in a proportion of not less than 7 wt %.

2. A method of producing a fuel hose material as set forth in claim 1, wherein the compound containing carbon nanotube and the polyamide resin are blended by means of a twin-screw kneading extruder.

3. A method of producing a fuel hose material as set forth in claim 1, wherein the polyamide resin comprises at least one selected from the group consisting of polyamide 11 (PA11), polyamide 12 (PA12) and polyamide 912 (PA912).

4. A method of producing a fuel hose material as set forth in claim 1, wherein the carbon nanotube is present in a proportion of 7 wt % to 15 wt %.

5. A method of producing a fuel hose material as set forth in claim 1, wherein the polar plasticizer is present in a proportion of 5 wt % to 15 wt %.

6. A fuel hose material produced by a method as set forth in claim 1.
